(19) United States
(12) Patent Application Publication
(10) Pub. No.: US 2024/0375953 A1
(43) Pub. Date: Nov. 14, 2024

(54) NET-ZERO HYDROGEN PLANTS AND METHODS OF OPERATION

(71) Applicants: Marian Simo, The Woodlands, TX (US); Tushar P. Vispute, Spring, TX (US)

(72) Inventors: Marian Simo, The Woodlands, TX (US); Tushar P. Vispute, Spring, TX (US)

(21) Appl. No.: 18/659,416

(22) Filed: May 9, 2024

Related U.S. Application Data
(60) Provisional application No. 63/501,199, filed on May 10, 2023.

(51) Int. Cl. C01B 3/34

(52) U.S. Cl. CPC C01B 3/34; C01B 2203/0205; C01B 2203/042; C01B 2203/049; C01B 2203/141; C01B 2203/168

(57) ABSTRACT

The present invention relates to net-zero hydrogen plants and methods of operating said plants having a lower cost and much larger scale compared to electrolysis driven plants utilized to produce green hydrogen.

### CROSS-REFERENCE TO RELATED APPLICATIONS

This application claims the benefit of U.S. Provisional Application No. 63/501,199 filed May 10, 2023, the disclosures of which are incorporated by reference.

### BACKGROUND OF THE INVENTION

### Field of the Invention

The present invention relates to net-zero hydrogen plants and methods of operating said plants having a lower cost and much larger scale compared to electrolysis driven plants utilized to produce green hydrogen. Specifically, the net-hydrogen plants have a carbon intensity close to 0 kg CO₂/kg H₂ (+/−0.5 kg/kg).

### Description of Related Art

Hydrogen has been produced at various scales using fossil feedstocks to achieve the lowest production cost. The choice of feedstock will be dependent on the access to feedstock, security of supply, price, and geography; but natural gas is the most common feedstock to produce hydrogen today. With the recent attention to greenhouse gas (GHG) emissions both academics and industrial sectors have been focusing on new technologies to reduce the carbon footprint of hydrogen production process.

Hydrocarbons such as natural gas, naphtha, or liquefied petroleum gas (LPG) can be catalytically converted with steam to obtain a synthesis gas (i.e., a mixture of hydrogen (H₂) and carbon monoxide (CO), commonly referred to as “syngas”) through several known processes such as steam methane reforming (SMR), autothermal reforming (ATR) or partial oxidation (POx). Deployment of carbon capture and storage (CCS) technology is one way to reduce GHG or primarily CO₂ emissions from these conventional fossil feedstock hydrogen production processes.

There are multiple technology and process flowsheet options available to capture carbon dioxide in the hydrogen production process that have been described extensively in the open literature. Captured carbon is in essence permanently stored in suitable geological formations or sequestered. The degree of carbon removal or carbon capture rate (CCR) can be in the range from 50% to 99%. However, even with highest degree of carbon capture rate it is not feasible to reduce emissions to reach the threshold for net-zero hydrogen. As utilized herein, net-zero hydrogen refers to the production of green molecules of hydrogen where effectively all (or close to all) CO₂ is removed during the production of green hydrogen molecules.

Another approach discussed in the related art is to utilize renewable feedstock such as biomass, biogas or pyoil (or others). The carbon dioxide produced from these feedstocks is biogenic. Since biogenic carbon is absorbed and stored by the flora of the planet through the process of photosynthesis its release to the atmosphere does not result in increased emissions, it is considered carbon neutral (i.e., it is part of natural carbon cycle). When the CCS technology is applied to biogenic feedstocks the carbon footprint is reduced significantly resulting in negative carbon emissions. In fact, it is possible to use biomass gasification to produce hydrogen with negative emissions if combined with CCS. However, this hydrogen production pathway is limited to small scale primarily due to technology and biomass supply chain and in addition the capital outlay is too large to support economics for a biomass hydrogen plant along with required utilities and infrastructure investment.

On the other hand, natural gas-based hydrogen production process (e.g., SMR, ATR, POx) has solved the problem of achieving the economy of scale translating to favorable hydrogen economics but is far from meeting the net-zero target. The implementation of CCS can reduce the overall carbon emissions by ˜70%. The remaining ˜30% can be mitigated by the negative emissions possible via the route of biomass gasification with CCS thus achieving the net zero objective. The combination of fossil and renewable feedstock with CCS enables the net-zero emissions and at the same time the capital efficiency of the fossil path translates to very competitive economics compared to electrolysis.

To overcome the disadvantages of the related art, it is an object of the present invention to utilize a combined hydrocarbon and biomass process train to achieve a net-zero hydrogen plant to produce green hydrogen. One of the benefits of such a plant is the viability of creating a large-scale plant. Another is the reduction in capital associated with the shared utilities, as further discussed below.

A further object of the invention is to provide a large-scale net-zero hydrogen plant by gasifying the natural gas and biomass separately to produce syngas which is further processed in a single hydrogen train (including its utilities) downstream to attain a zero carbon intensity hydrogen product.

Other objects and aspects of the present invention will become apparent to one of ordinary skilled in the art upon review of the specification, drawings and claims appended hereto.

### SUMMARY OF THE INVENTION

According to an aspect of the invention, a method producing a low carbon intensity hydrogen in a net-zero hydrogen product plant including:
processing a hydrocarbon feedstock in a reforming unit to obtain a first syngas stream;
processing a biomass in a gasifier unit to obtain a second syngas stream;
capturing and sequestering the carbon dioxide from the first and second syngas stream; and
combining the first and second syngas stream at a ratio of dry syngas at a ratio of first syngas stream to that of the second syngas stream of 3 to 6.

In accordance with another aspect of the invention, a net-zero hydrogen plant is provided where the carbon intensity of the hydrogen produced is 0.5 kgCO₂/kgH₂ or less. The plant includes:
a first reforming train to process the hydrocarbon feedstock and produce a first syngas stream;
a second reforming train to process a biomass based feedstock and produce a second syngas stream;
combining the streams and further processing the resulting syngas stream in a shift reactor, carbon capture unit and a pressure swing adsorption unit to obtain a hydrogen having a carbon intensity of 0.5 kgCO₂/kgH₂ or less.

### BRIEF DESCRIPTION OF THE FIGURES

The objects and advantages of the invention will be better understood from the following detailed description of the preferred embodiments thereof in connection with the accompanying figure wherein like numbers denote same features throughout and wherein:

FIG. 1 is a process flow diagram illustrating the various operation units of a blue hydrogen plant processing a hydrocarbon feedstock.

FIG. 2 is a process flow diagram illustrating the various operation units of a biomass gasification plant processing a biomass feedstock.

FIG. 3 is a process flow diagram illustrating the various operation units for a large-scale net-zero hydrogen plant in accordance with an exemplary embodiment of the invention.

FIG. 4 is a process flow diagram illustrating the various operation units for a large-scale net-zero hydrogen plant in accordance with another exemplary embodiment of the invention with parallel trains.

### DETAILED DESCRIPTION OF THE INVENTION

The present invention provides a novel plant and process to produce net-zero emissions hydrogen where it enables the production of hydrogen at large scale and at the same time achieving favorable economics compared to state-of-the-art alternatives. At least one fossil and at least one renewable hydrocarbon feedstock has to be utilized in order to produce at least two syngas streams which are further processed by downstream processes to capture and sequester the carbon molecules and to convert the syngas streams into hydrogen. Certain exemplary embodiments of the invention will be described in greater detail, below; however, the invention is not limited to the embodiments set forth herein.

The hydrogen environmental attributes are often associated with various colors to describe the production pathway (i.e., technical means) and/or feedstock utilized in the production process. This is in many cases misleading and to address this challenge the hydrogen carbon intensity (CI) metric has been developed and now widely adopted by the industry and academia. Carbon intensity refers to; and also utilized herein, as a quantity of lifecycle GHG emissions per unit of hydrogen and is typically expressed as equivalent carbon dioxide emissions per one kilogram of hydrogen. The primary tool to determine the carbon intensity is the Life Cycle Analysis (LCA) which estimates the product or fuel emissions over its entire life cycle. A person skilled in the art will understand that various LCA methodologies to calculate the carbon intensity can be employed and various regulatory or voluntary frameworks can be applied. The hydrogen carbon intensity values referenced in this invention use The Greenhouse gases, Regulated Emissions, and Energy use in Technologies Model (i.e., GREET model promulgated by the Argonne National Laboratory, Argonne GREET Model (anl.gov)).

One of the assumptions in LCA is the definition of system boundary; the “well-to-gate” (WTG) system boundary will be considered in the accounting for the emissions in the context of the present invention since it is more suitable for hydrogen production process. The system boundary is a key assumption for the LCA and a person skilled in the art will understand that changing the system boundary will result in different carbon intensity. The “well-to-gate” boundary considers the emissions from feedstock supply chain and the emissions from the hydrogen production process itself. It simply does not include the emissions associated with end use of hydrogen.

The hydrogen production emissions are typically classified into three categories per definition outlined in Greenhouse Gas Protocol (GHG) Standard (Corporate Standard|GHG Protocol). The definition here does not go into full detail, the rigorous calculation of carbon intensity is covered by ISO standards and regulatory frameworks. Three key emissions contributions to hydrogen carbon intensity are considered here to illustrate the invention.

The plant atmospheric emissions are referred to as “Scope 1 emissions”. These are also referred to as direct emissions accounting for all atmospheric emissions of the plant the stack flue gas being the major one. All constituents of the flue gas are expressed as carbon dioxide equivalent emissions according to their global warming potential factors. Since carbon dioxide is the major constituent of the flue gas, we will limit the discussion just to carbon dioxide (CO₂). “Scope 2 emissions” account for energy imports such as power or steam. For the sake of simplicity, we will limit these to the electricity imported from the grid and consumed by the hydrogen production facility. As per these definitions, the scope 1 and scope 2 emissions are directly related to the hydrogen production facility; the choice of the technology employed, operational efficiency and emissions mitigation measures in place will have a major impact on scope 1 and scope 2 emissions. The last category is the “Scope 3 emissions” which are associated with the emissions of feedstock production and supply chain (i.e., the feedstock emissions from the point of extraction to the point of delivery to the gate of the plant including the emissions associated with the transport of the feedstock).

At least two different feedstocks must be used in the disclosed novel net-zero plant and production method: (1) fossil feedstock and (2) renewable feedstock. Preferred fossil feedstock is natural gas but the scope of the invention is not limited to it. The renewable feedstock can be liquid or solid biogenic feedstock. Some examples are woody biomass, wood chips, forest waste, MSW, pyoil and others. Biogenic feedstock is carbon neutral meaning the consumption of biogenic feedstock (as fuel or feedstock) and subsequent emissions do not contribute to atmospheric emissions. In other words, the Scope 1 emissions for biogenic feedstock are zero. This major difference between fossil and biogenic feedstock is the unique ability of biogenic feedstocks to generate “negative emissions” when combined with carbon capture and sequestration.

The most common and most economical method to produce hydrogen today at scale is the reforming of natural gas. As discussed above, this can be done via known reforming methods such as SMR, POx or ATR. Other fossil feedstocks can be used such as coal, LPG or naphtha. The SMR process employing natural gas will be used here as the state-of-the-art method to produce gray hydrogen with the associated carbon intensity around 10 kg of carbon dioxide equivalent per kg of hydrogen (kg CO₂/kg H₂).

In the SMR process natural gas is first pretreated to remove any contaminants that can negatively impact downstream unit operations, then the steam is introduced and resulting mixture is preheated to high temperature. The chemical conversion of hydrocarbons in the natural gas to syngas is accomplished in the steam methane reformer unit. Syngas, as utilized herein, will be understood as being a mixture of hydrogen, carbon monoxide, carbon dioxide, water and methane as the key components and some other minor constituents such as ethane or ammonia. The mixture of hydrogen, carbon monoxide, carbon dioxide and methane is referred to as dry syngas. To further improve the hydrogen yield, a shift unit is utilized where the carbon monoxide and water is converted into carbon dioxide and hydrogen via water gas shift reaction. The final step to produce high purity hydrogen is a pressure swing adsorption (PSA) unit that separates hydrogen from the remaining carbon monoxide, carbon dioxide, methane, and water. The steam methane reforming is endothermic process where the heat to the SMR operation unit is provided via PSA tail gas stream containing all impurities and un-recovered hydrogen from PSA unit and additional firing duty is supplied by natural gas used as fuel. The combustion process in the SMR furnace will generate process emissions that are emitted to the atmosphere.

Blue hydrogen production methods, by way of comparison, are still utilizing fossil feedstock and they are using a reforming process such as SMR, ATR or POx, followed by water gas shift and carbon capture to reduce the carbon emissions. This hydrogen production process maintains the large-scale advantage of gray hydrogen. In many cases to improve the process economics the scale of blue hydrogen can be even larger than conventional gray hydrogen plants. On the other hand, the blue hydrogen process still utilizes fossil feedstock which has significant scope 1 and scope 3 emissions so even if one were to capture 100% of the Scope 1 emissions the Scope 3 emissions will always remain. In addition, the blue hydrogen plants can consume large amounts of power translating to corresponding Scope 2 emissions meaning the resulting hydrogen carbon intensity of blue hydrogen is greater than zero. This is the key limitation of the blue hydrogen pathway where a tradeoff between higher carbon capture rate, power use and associated investment capex is prohibitive to reach favorable economics and zero CI target. To offset the Scope 2 emissions one can source or produce renewable power. The Scope 3 emissions can be reduced by sourcing lower supply chain emissions natural gas also referred to and understood by those skilled in the art as certified natural gas. “Certified natural gas” is natural gas that has been verified by an independent third-party organization to have been produced in a manner consistent with certain environmental, social, and governance standards. A key aspect of certified natural gas is the reduction of methane emissions and leakage, which contribute to climate change. Certified natural gas may have a higher price than regular natural gas, but it offers a low-cost, near-term, and practical solution to lower the emissions intensity of the gas sector. The scope 3 emissions reduction using certified natural gas relative to conventional natural gas is less than 30% and hence achieving the zero CI target still remains a challenge. Typical values for carbon intensity of blue hydrogen in the open literature are between 2 to 4 kg CO₂ₑ/kg H₂.

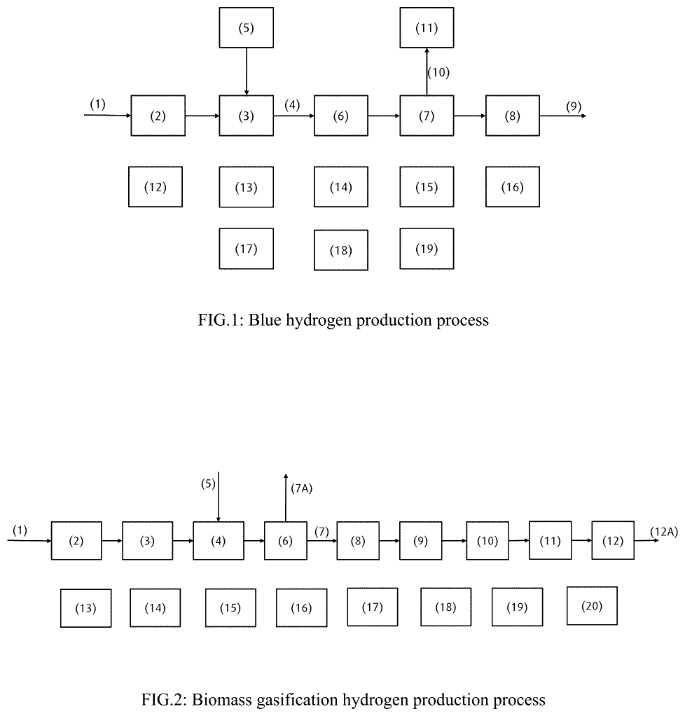

Turning to a blue hydrogen process, and as shown in FIG. 1, an exemplary embodiment of the ATR based blue hydrogen production process is provided. Natural gas feedstock is supplied to the facility via pipeline (1). Natural gas is fed to pretreatment unit (2) to remove impurities and to convert higher hydrocarbons using steam to meet the requirements for ATR unit (3). The autothermal reformer converts the feedstock into syngas (4) by reacting it with steam and oxygen supplied by air separation unit (ASU) (5). The hot syngas is routed to syngas cooling and shift (6) portion of the process where the hydrogen content of syngas is further increased using the water gas shift reaction. This part of the plant has high degree of heat integration to recover the heat from syngas to generate steam, pre-heat boiler feed water and supply heat to other parts of the process. A typical dry syngas composition upstream of the shift unit is ˜25% carbon monoxide, ˜6% carbon dioxide, less than 2% methane and balance hydrogen. In a well-designed blue hydrogen plant the dry syngas downstream of the shift reactor is primarily composed of hydrogen and carbon dioxide with low concentrations of carbon monoxide and methane. Dry syngas composition will typically have less than 1% (molar) carbon monoxide, methane less than 2% (molar), carbon dioxide is typically between ˜26% and the balance is hydrogen. Carbon capture unit (7) can be employed at this point of the process to separate carbon dioxide from the syngas. Remaining syngas is introduced to PSA unit (8) to produce pure hydrogen product (9). Carbon dioxide stream (10) needs to be compressed to high pressures required for geological sequestration in the CO₂ compressor (11). The remaining off-gases from carbon capture and PSA unit are integrated back into the overall process as fuels and/or recycled as feedstock. The core blue hydrogen process described above requires utilities and supporting infrastructure. The purpose of fired heater(s) and fuel system (12) is to provide necessary pre-heating to ATR unit during normal operation and start-up and it is designed to satisfy overall facility energy balance, it can produce additional steam for steam turbine, or it may be designed just to minimize overall investment capital while meeting the hydrogen CI target. The steam system (13) can be quite complex producing steam at different pressure levels and quality. It is common for the process to generate excess steam that is used for power generation in steam turbine (14). The blue hydrogen plant also requires significant quantities of water for process to generate steam and hydrogen but also to supply water for cooling system (15). All water related unit operations such as water intake, clarifiers, demin water unit, condensate collection and treatment and captured as water plant (16) in FIG. 1. Wastewater treatment (17) plant is needed to process plant effluents and fire water (18) is needed to meet safety requirements. Power is typically supplied by the grid at high voltage, so the substation and transformers (19) are needed to step down and distribute the voltage for individual equipment. This overview of blue hydrogen facility is not complete with full detail, the key takeaway is that plant utilities and infrastructure comprise a large portion of the overall cost of the hydrogen facility and are necessary to produce the hydrogen product.

Now turning to a biomass gasification process utilized to produce hydrogen as depicted in the embodiment of FIG. 2. Biomass feedstock (1) is delivered to the production facility where in may undergo additional processing (2) such as size adjustment, sorting, quality control, then it will be routed to feedstock storage. Moisture content may need to be reduced using a dryer unit (3) prior to introducing biomass feed into gasifier (4). Multiple technology platforms have been developed for biomass gasification, the detailed description of which is not necessary here and a person skilled in the art will understand how to apply to present embodiment with any type of liquid and solid biomass gasification technology. In most cases biomass is gasified using steam and/or oxygen. Oxygen stream (5) can be produced on-site with ASU or VPSA process or it can be provided to the facility via pipeline. Partial oxidation unit (POx) (6) can be employed downstream of the gasifier to produce higher quality syngas and increase carbon conversion with the addition of supplemental oxygen. The gasifier and POx will convert the biomass into a syngas stream (7) and ash (7A) that is collected on the bottom and disposed of as waste. In the next section of the facility/plant, the hot syngas is cooled to recover heat and clean-up unit (8) to remove minor impurities that can interfere with downstream catalytic units. Some gasification systems operate at low pressure so it may be advantageous to increase the pressure using syngas compressor (9) at this point to reduce the size of downstream equipment and improve efficiency of the overall process. The biomass derived dry syngas composition at this point can be ˜41% carbon monoxide, ˜28% carbon dioxide, ˜30% hydrogen and less than 1% methane. The exact syngas composition will be a function of feedstock used and gasification process employed but it is obvious that it has much lower hydrogen content and large portion is comprised of carbon oxides. Syngas hydrogen content will be increased in the shift unit (10). The dry syngas composition downstream of the shift reactor(s) can be less than 1% carbon monoxide, less than 1% methane, ˜48% carbon dioxide and balance hydrogen. Next, carbon capture unit (11) is employed to remove most of carbon dioxide followed by a PSA unit (12) to produce final hydrogen product (12A). This description will constitute the core hydrogen plant; however, the supporting utilities and infrastructure will be required just as it was the case for blue hydrogen plant: steam system (13), steam turbine and power generation (14), cooling system (15), water plant (16), wastewater treatment (17) plant, fire water (18), substation and transformers (19) and fuel management system with optional fired heater(s) (20).

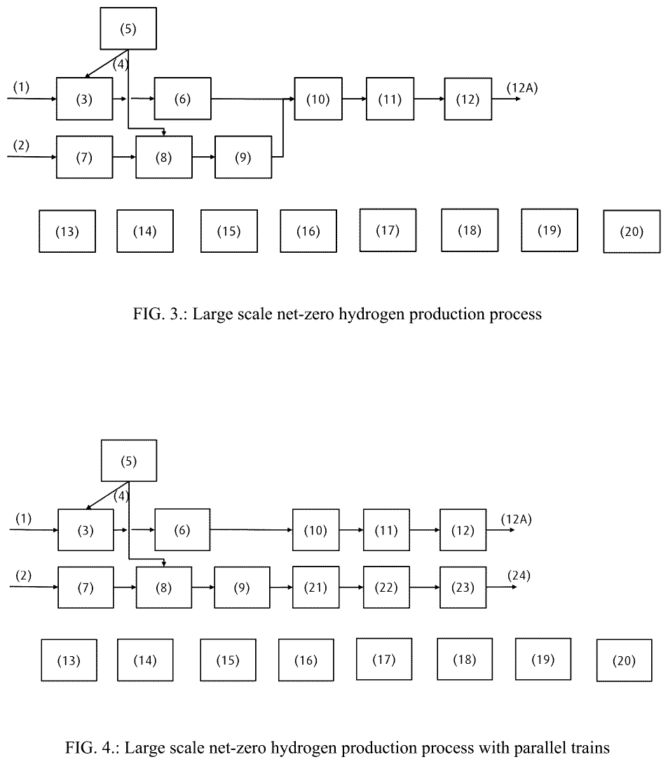

The large-scale net-zero hydrogen production plant and process is shown in FIG. 3 depicting one of the preferred embodiments of the invention. Natural gas (1) and biomass (2) are used as primary feedstocks; additional fossil and/or biogenic feedstocks can be utilized as well. Natural gas is fed to pre-treatment and reforming units (3) to produce fossil syngas with the aid of steam and/or oxygen. ATR, SMR or POx process can be viable technology platform for natural gas reforming, as discussed above regarding the exemplary embodiment of FIG. 1 where an ATR is employed (i.e., syngas generating train based on hydrocarbon feedstock). A stream of oxygen (4) can be supplied by Air Separation Unit (ASU) or via pipeline from ASU (5). Syngas cooling (6) equipment is used to recover valuable heat from the hot syngas. The typical natural gas fed ATR process dry syngas composition is ˜30% carbon monoxide, ˜8% carbon dioxide, less than 2% methane and balance is hydrogen (˜60%).

Biomass feedstock is stored, treated and conditioned in operational unit (7) (e.g. quality control, size reduction, drying) prior to sending it to gasifier (8) where it is converted to renewable syngas with the aid of steam and oxygen (i.e., a biomass/gasifier syngas generating train). Hot syngas is cooled and cleaned in operation unit (9) to meet the quality requirements for downstream units. The pressure of the syngas from the gasifier train is increased to match the syngas pressure of the fossil syngas, typical pressure is 25 barg. The composition of biomass based dry syngas leaving block (9) can be ˜41% carbon monoxide, ˜28% carbon dioxide, ˜30% hydrogen and less than 1% methane. The blending of fossil and renewable syngas streams is the essential aspect of the present invention disclosure. In order to achieve net-zero CI hydrogen the quantity of renewable syngas has to be sufficient to offset all (Scope 1, Scope 2 and Scope 3) emissions from fossil syngas and process emissions of combined syngas process units. These quantities and corresponding emissions are explained in greater detail in the examples but for illustrative purposes the ratio of dry syngas flows should be between 3 to 6.

At this point in process a shift reactor(s) & syngas cooling (10) is employed to increase hydrogen and carbon dioxide content of the mixed syngas leveraging the water gas shift reaction. A representative dry syngas composition will have less than 0.5% of methane, less than 1% of carbon monoxide, ˜30% of carbon dioxide and hydrogen content will be close to 68% (all molar). Next the carbon dioxide can be removed using carbon capture unit (11) followed by a PSA (12) unit to produce high purity hydrogen product (12A) that meets the purity specifications. Since both syngas streams are combined into common train.

The utilities and infrastructure will be shared between the two or more syngas generating trains and common shift, CO₂ capture and H₂ recovery, namely the steam system (13), steam turbine and power generation (14), cooling water system (15), water plant (16), wastewater treatment (17) plant, fire water (18), substation and transformers (19) and fired heater(s) and fuel system (20). Other components of the plant not listed here may apply such as flare system, control system, control room and warehouse facilities etc. This aspect of the invention enables the capital efficiency. For illustration, let us assume that fossil dry syngas volume is five time greater than the biomass based dry syngas so to accommodate the utilities and infrastructure requirements for the biomass train about the investment capital for this portion of the facility will increase by about 20% using fossil train utilities and infrastructure capital as the base. This will significantly improve the overall plant economics and enable the production of net-zero hydrogen at large scale.

In another preferred embodiment of the present invention and with reference to FIG. 4, the backend of the plant is not common but the fossil syngas and biogenic syngas trains both have their own dedicated shift, carbon capture and PSA unit. The same utilities and infrastructure can be shared by both trains to realize investment capital savings. The frontend of the plant looks identical to process described in FIG. 3 up to the syngas cooling units (6) and (9) in the respective trains. Dedicated units for biogenic syngas were added to the flowsheet such as Shift & syngas cooling (21), carbon capture (22) and PSA unit (23) to recover hydrogen product (24) and capture CO₂ from biomass-derived syngas. This arrangement can be the method of choice when it comes to a retrofit of an existing facility and for conversion of gray or blue hydrogen plant into a net-zero hydrogen plant.

The invention is further explained through the following example, which compares the base blue hydrogen; biomass gasification plant processes and water electrolysis versus that of the net-zero hydrogen plant and process of the present invention, which example is not to be construed as limiting the present invention.

### Example 1

To best illustrate the advantage of the proposed net-zero hydrogen plant and production method various technology pathways will be reviewed with their corresponding carbon intensity values. Table 1 summarizes following cases: 1.) blue hydrogen plant, 2.) biomass gasification hydrogen plant and 3.) Net-zero hydrogen plant. Blue hydrogen process example is an ATR-based process with CCS using natural gas as feedstock per the embodiment exemplified in FIG. 1. Biomass gasification process is using woody biomass feedstock with CCS according to the embodiment of FIG. 2. Net-zero hydrogen process is based on technology choices listed in description of one of the embodiments of the present invention, and as shown in FIG. 3.

TABLE 1
Summary of H₂ production methods and
relative hydrogen production cost

| | Blue | Biomass | Net-zero |
|---|---|---|---|
| | Hydrogen | gasification | Hydrogen |
| | plant | H2 plant | Plant |
| Natural Gas, MMSCFD | 51.5 | | 51.5 |
| Biomass, stpd | | 1,000 | 1,000 |
| Power, MW | 40 | 20 | 58 |
| Carbon dioxide, mTPD | 2,675 | 1,110 | 3,963 |
| Hydrogen, MMD | 131 | 22 | 155 |
| Dry syngas flow (un-shifted) | 161 | 37.8 | 198.8 |
| Emissions [kgCO₂e/kgH2]: | | | |
| Scope 1 (natural gas) | 8.71 | 0 | 7.38 |
| Scope 3 (natural gas) | 1.86 | 0 | 1.58 |
| Scope 1 (biomass) | 0 | 0 | 0 |
| Scope 3 (biomass) | 0 | 1.57 | 0.22 |
| Scope 2 (power) | 1.14 | 3.33 | 1.36 |
| Captured CO₂ | −8.62 | −20.8 | −10.65 |
| Hydrogen Carbon Intensity | 3.1 | −15.9 | −0.1 |
| [kgCO₂e/kgH2] | | | |

The process production and consumptions figures for each example plant are converted into emissions using published emission factors for natural gas, power and biomass. For the blue hydrogen plant the scope 1 and scope 3 values are emissions associated with the natural gas. The CO₂ stream captured in the process will significantly reduce scope 1 emissions (8.62/8.7*100%=˜99%) but it has no impact on scope 3 emissions. The power emissions are covered under the scope 2 emissions. The resulting H₂ CI is close to ˜3 kg/kg. Comparing this value to 10 kg/kg for gray hydrogen, the blue hydrogen process is reducing the carbon emissions by ˜70%.

The biomass gasification hydrogen plant uses biogenic feedstock translating to zero scope 1 emissions; however, there will be scope 3 emissions accounting for feedstock extraction, processing, and transportation to the production facility. The carbon dioxide captured and sequestered in the process will yield significant negative carbon emissions resulting in negative CI hydrogen overall.

The net-zero hydrogen plant combines the emissions' attributes of both fossil and renewable feedstock where the goal is meet two objectives: 1.) net-zero CI hydrogen and 2.) large scale to achieve attractive economics. Biomass gasification hydrogen plants do not currently have favorable economics on their own because they are limited to smaller scale due to feedstock supply chain and technology capex inefficiency (many parallel trains are needed to achieve scale). But if the biomass gasification hydrogen pathway is combined with the blue hydrogen plant significant synergies can be achieved delivering on both CI and the economies of scale.

### Example 2

TABLE 2
Summary of H₂ production methods and
relative hydrogen production cost

| | | | Relative H₂ |
|---|---|---|---|
| | Plant capacity, | Hydrogen CI, | production cost |
| | MMSCFD | kg CO₂ₑ/kg H₂ | (blue = base) |
| Blue Hydrogen | 100 to 400 | ~3.0 | 1.0 |
| Biomass gasification | <20 | ~−15 | ~8 |
| hydrogen | | | |
| Net-zero hydrogen | 100 to 400 | ~0 | ~2.5 |
| Electrolysis hydrogen | <1 | ~0 | ~6 |

The plant capacities listed in Table 2 are showing typical commercial production scale for each technology platform assuming a single unit or module along with the representative hydrogen CI values. Immediate takeaway for both the biomass gasification and electrolysis pathway is that parallel trains must be used to achieve higher production capacities which will not allow for the economies of scale to be achieved compared to single train blue or net-zero concepts. The production cost advantage of net-zero hydrogen process over electrolysis hydrogen is evident from Table 2.

While the invention has been described in detail with reference to specific embodiments thereof, it will become apparent to one skilled in the art that various changes and modifications can be made, and equivalents employed, without departing from the scope of the appended claims.

What is claimed is:

1. A method for producing a low carbon intensity hydrogen in a net-zero hydrogen product plant, comprising:
processing a hydrocarbon feedstock in a reforming unit to obtain a first syngas stream;
processing a biomass in a gasifier unit to obtain a second syngas stream;
capturing and sequestering the carbon dioxide from the first and second syngas stream; and
combining the first and second syngas stream at a ratio of dry syngas at a ratio of first syngas stream to that of the second syngas stream of 3 to 6.

2. A method for producing a low carbon intensity hydrogen in a net-zero hydrogen product plant, comprising:
processing a hydrocarbon feedstock in a hydrocarbon reformer train to obtain a first syngas stream;
processing a biomass feedstock in a biomass train to obtain a second syngas stream;
capturing and sequestering the carbon dioxide from the first and second syngas streams; and
further processing the first and second syngas streams to obtain a combined hydrogen stream having a carbon intensity of 0.5 kgCO₂/kgH₂.

3. A net-zero hydrogen plant, wherein the carbon intensity of the hydrogen produced is 0.5 kgCO₂/kgH₂ or less, comprising:
a first reforming train to process the hydrocarbon feedstock and produce a first syngas stream;
a second reforming train to process a biomass based feedstock and produce a second Syngas stream; and
combining the streams and further processing the resulting syngas stream in a shift reactor, carbon capture unit and a pressure swing adsorption unit to obtain a hydrogen having a carbon intensity of 0.5 kgCO₂/kgH₂ or less.

4. The net-zero hydrogen plant of claim 3, wherein the first and second reforming trains are run in parallel with shared utilities.
